(19) United States
(12) Patent Application Publication
(10) Pub. No.: US 2026/0030905 A1
(43) Pub. Date: Jan. 29, 2026

(54) Vision-Language-Model-Based System for Assessing the Consistency Between Images and Their Textual Description

(71) Applicant: Google LLC, Mountain View, CA (US)

(72) Inventors: Michal Yarom Zarfati, Herzliya (IL); Yehonatan Bitton, Givatayim (IL); Soravit Changpinyo, Los Angeles, CA (US); Idan Szpektor, Kfar Saba (IL); Eran Ofek, Rehovot (IL); Oran Lang, Ramat Gan (IL); Roee Aharoni, Tel Aviv (IL); Jonathan Herzig, Tel Aviv (IL); Hagai Taitelbaum, Lod (IL); Michal Sokolik, Tel Aviv (IL); Brian Gordon, Herzliya (IL); Itay Laish, Timrat (IL)

(21) Appl. No.: 19/217,945

(22) Filed: May 23, 2025

Related U.S. Application Data
(60) Provisional application No. 63/648,995, filed on May 17, 2024.

(51) Int. Cl. G06V 20/70; G06V 10/25

(52) U.S. Cl. CPC G06V 20/70; G06V 10/25; G06V 2201/07

(57) ABSTRACT

A computer system generates descriptions of image-text misalignments. The system includes one or more processors and models for generating textual and visual descriptions of misalignments between a source text string and a source image. The textual description identifies misaligned text segments, while the visual description may include bounding boxes indicating the location of the misalignment. This system automatically generates synthetic image-text misalignment training examples and feedback, which includes generating misalignment captions and visual bounding box labels.

### PRIORITY CLAIM

The present application claims priority to and the benefit of U.S. Provisional Patent Application No. 63/648,995 filed May 17, 2024, which is hereby incorporated by reference herein in its entirety.

### FIELD

The present disclosure relates generally to machine learning processes and machine-learned devices and systems. More particularly, the present disclosure relates to a vision-language-model-based system for assessing the consistency (also known as “alignment”) between images and their textual description.

### BACKGROUND

Vision-Language Models (VLMs) have recently shown promise in understanding and relating visual and textual information. These models are used in tasks such as image captioning, visual question answering, and text-to-image generation. However, existing VLM systems often struggle to accurately evaluate the semantic consistency, or alignment, between images and their corresponding textual descriptions. For instance, state-of-the-art VLMs sometimes generate inaccurate image descriptions, misleading captions, or provide incorrect responses in visual question answering tasks, indicating a misalignment between the visual and textual content.

Existing approaches to evaluating image-text alignment often rely on comparing textual similarity between a generated caption and a reference caption. These metrics, however, are limited in their ability to capture the nuanced semantic relationships between images and text. They often fail to identify subtle but critical inconsistencies. For example, an image of a “red car” might be incorrectly described as a “blue vehicle,” and similarity metrics alone may not adequately penalize this misalignment.

Furthermore, embedding-based models like CLIP and ALIGN, which aim to align image and text embeddings in a shared space, also have limitations. While effective at capturing high-level semantic similarities, these models often struggle with tasks requiring fine-grained reasoning and compositional understanding. For instance, they may fail to accurately relate the spatial relationships between objects depicted in an image or may misinterpret complex interactions described in the text. Moreover, multimodal pre-trained models often lack generalizability, performing well on datasets they were trained on but struggling with out-of-distribution examples. There is a need to overcome these limitations.

### SUMMARY

Aspects and advantages of embodiments of the present disclosure will be set forth in part in the following description, or can be learned from the description, or can be learned through practice of the embodiments.

One example aspect is directed to a computer system for analysis of image-text misalignment. The computer system includes one or more processors and one or more non-transitory computer-readable media that collectively store: a machine-learned misalignment description model configured to receive and process a source text string and a source image to generate both (i) a textual description of an image-text misalignment between the source text string and the source image and (ii) a visual description of an image-text misalignment between the source text string and the source image; wherein the textual description comprises identification of one or more misaligned text segments that correspond to the image-text misalignment between the source text string and the source image; and the visual description identifies one or more visual elements that correspond to the image-text misalignment between the source text string and the source image.

In some implementations, the machine-learned misalignment description model is also further configured to compare the source text string to the source image and generate a first alignment score. In some implementations, the visual description comprises one or more bounding boxes. In some implementations, the misalignment description model generates the visual description of the image-text misalignment by: receiving the textual description of the image-text misalignment, and generating the one or more bounding boxes based on the textual description of the image-text misalignment. In some implementations, the misalignment description model is configured to generate a second textual description of a second misalignment between the source text string and the source image, and the misalignment description model is configured to generate a second visual description of the second misalignment. In some implementations, the computing system further comprises an alignment correction model configured to correct the image-text misalignment before the misalignment description model generates the second textual description of the second misalignment.

Another example aspect is directed to a computer-implemented method for automatic generation of synthetic image-text misalignment training examples and feedback, the method comprising: obtaining, by a computing system comprising one or more computing devices, an image and one or more positive text strings that describe image content depicted by the image; generating, with a language model, one or more misalignment captions that introduce a target misalignment, the one or more misalignment captions including an explanation of the target misalignment and a misalignment cue that specifies a misaligned element in the one or more misalignment captions; and generating, with a visual grounding model, a visual bounding box label for the image corresponding to the one or more misalignment captions.

In some implementations, the method include filtering, by the computing system, the one or more misalignment captions with entailment validation; and storing, by the computing system, one or more remaining misalignment captions. In some implementations, filtering the one or more misalignment captions with entailment validation comprises: evaluating, by an entailment model, the one or more positive text strings as a contradiction correction premise and the misalignment caption as a contradiction correction hypothesis, to determine a contradiction correctness level; evaluating, by the entailment model, the one or more positive text strings and the misalignment caption as a feedback correctness premise, and a generated feedback as a feedback correctness hypothesis, to determine a feedback correctness level; and removing, by the computing device, the one or more misalignment captions from the synthetic image-text misalignment training examples and feedback if either the contradiction correctness level or the feedback correctness level fail to satisfy a threshold. In some implementations, the target misalignment comprises an object misalignment, an attribute misalignment, an action misalignment, and a spatial relation misalignment.

Another example aspect is directed to a computer-implemented method for automatic generation of synthetic image-text alignment training examples, the method comprising: obtaining, by a computing system comprising one or more computing devices, an image and one or more positive text strings that describe image content depicted by the image; processing, by the computing system, at least one of the one or more positive text strings with a machine-learned sequence processing model to generate, as an output of the machine-learned sequence processing model, one or more candidate negative text strings that each contradict at least one of the one or more positive text strings; and storing, by the computing system, at least one of the candidate negative text strings together with the image as an image-text alignment training example.

In some implementations, the method includes retrieving, by the computing system, the image-text alignment training example from memory; and training, by the computing system, a visual-language model on the image-text alignment training example. In some implementations, obtaining, by the computing system, the image and the one or more positive text strings comprises: obtaining, by the computing system, the image; and processing, by the computing system, the image with a machine-learned caption generation model to generate, as an output of the machine-learned caption generation model, at least one of the one or more positive text strings. In some implementations, processing, by the computing system, at least one of the one or more positive text strings with the machine-learned sequence processing model comprises processing, by the computing system, the at least one of the one or more positive text strings with the machine-learned sequence processing model while conditioning the machine-learned sequence processing model with instruction data, wherein the instruction data instructs the machine-learned sequence processing model to provide a caption that contradicts the at least one of the one or more positive text strings. In some implementations, the one or more positive text strings comprise a plurality of positive text strings; and processing, by the computing system, at least one of the one or more positive text strings with the machine-learned sequence processing model comprises processing, by the computing system, the plurality of positive text strings with the machine-learned sequence processing model while conditioning the machine-learned sequence processing model with instruction data, wherein the instruction data instructs the machine-learned sequence processing model to provide a caption that contradicts all of the plurality of positive text strings. In some implementations, the one or more candidate negative text strings comprise a plurality of candidate negative text strings; and the method further comprises: respectively processing, by the computing system, each candidate negative text string and the image with a natural language inference model to generate, as an output of the natural language inference model, a respective entailment score for each candidate negative text string; selecting, by the computing system, the at least one of the candidate negative text strings for inclusion in the image-text alignment training example based on the respective entailment score generated for each candidate negative text string. In some implementations, the machine-learned sequence processing model comprises a language model.

Another example aspect is directed to one or more non-transitory computer-readable media that collectively store instructions that, when executed by a computing system comprising one or more computing devices, cause the computing system to perform operations, the operations comprising: obtaining, by the computing system, an input image and an input text string associated with the input image; extracting, by the computing system, one or more answer spans from the input text string; respectively processing, by the computing system, each answer span and the input text string with a machine-learned question generation model to generate, as an output of the machine-learned question generation model, a respective question text string; respectively processing, by the computing system, each respective question text string and the input image with a machine-learned visual question answering model to determine a respective answer score for the corresponding answer span; and generating, by the computing system, an alignment score for the input image and the input text string based on the respective answer score for each answer span.

In some implementations, the one or more answer spans comprise a plurality of answer spans, and wherein generating, by the computing system, the alignment score for the input image and the input text string comprises averaging the respective answer scores associated with the plurality of answer spans. In some implementations, respectively processing, by the computing system, each respective question text string and the input image with the machine-learned visual question answering model to determine the respective answer score for the corresponding answer span comprises: structuring the respective question text string and the respective answer span as binary question; and determining the respective answer score as a probability of the machine-learned visual question answering model providing a positive binary output.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a graphical diagram that depicts an example misalignment description process for generating a textual description and a visual description of an image-text misalignment according to example embodiments of the present disclosure.

FIG. 2 is a graphical diagram that depicts an example iterative misalignment correction process for generating and fixing sequential image-text misalignments according to example embodiments of the present disclosure.

FIG. 3 is a chart that depicts an example automatically generated synthetic image-text misalignment training dataset according to example embodiments of the present disclosure.

FIG. 4 is a chart that depicts an example comprehensive text-image alignment benchmark dataset according to example embodiments of the present disclosure.

FIG. 5 is a graphical diagram of an example benchmark generation process according to example embodiments of the present disclosure.

FIG. 6 is a graphical diagram that depicts an example method for generating an alignment score according to example embodiments of the present disclosure.

FIG. 7 is a block diagram of an example computing system that performs information retrieval according to example embodiments of the present disclosure.

FIG. 8 is a block diagram of an example computing system that performs information retrieval according to example embodiments of the present disclosure.

FIG. 9 is a flow chart diagram illustrating an example method for training a machine-learned model according to example implementations of aspects of the present disclosure.

FIG. 10 is a block diagram of an example processing flow for using machine learned model(s) to process input(s) to generate output(s) according to example implementations of aspects of the present disclosure.

FIG. 11 is a block diagram of an example sequence processing model according to example implementations of aspects of the present disclosure.

FIG. 12 is a block diagram of an example technique for populating an example input sequence for processing by a sequence processing model according to example implementations of aspects of the present disclosure.

FIG. 13 is a block diagram of an example model development platform according to example implementations of aspects of the present disclosure.

FIG. 14 is a block diagram of an example training workflow for training a machine-learned model according to example implementations of aspects of the present disclosure.

FIG. 15 is a block diagram of an inference system for operating one or more machine-learned model(s) to perform inference according to example implementations of aspects of the present disclosure.

FIG. 16 is a block diagram of an example networked computing system according to example implementations of aspects of the present disclosure.

FIG. 17 is a block diagram of an example computing device according to example implementations of aspects of the present disclosure.

FIG. 18 is a block diagram of an example computing device according to example implementations of aspects of the present disclosure.

### DETAILED DESCRIPTION

Current vision-language models (VLMs) struggle with accurately and consistently evaluating the semantic alignment between images and text, hindering applications like text-to-image generation, image captioning, and visual question answering. These models often fail to capture subtle nuances in meaning and struggle with complex compositions or unnatural images. This leads to issues such as inaccurate image generation, misleading captions, and incorrect responses in visual question answering.

Further, while existing technologies like Visual Question Answering (VQA) models and multimodal pre-trained models like CLIP and ALIGN show promise, they have limitations. Embedding Based Models (e.g., CLIP) often struggle with complex reasoning and compositional understanding, limiting their applicability to specific image-text matching tasks. While multimodal pre-trained models achieve impressive results on specific tasks, they lack the generalizability needed for diverse image-text matching challenges encountered in real-world scenarios. Textual similarity metrics (e.g., BLEU, ROUGE) are often insufficient for evaluating semantic alignment as they only assess textual similarity, ignoring visual information and deeper semantic connections.

In view of the above challenges, the example aspects of the present disclosure are directed to a vision-language-model-based system for assessing the consistency (also known as “alignment”) between images and their textual description. In particular, a computing system can include a vision-language-model (VLM). Example VLMs include the PaLI and Gemini model families.

More particularly, one example aspect of the present disclosure is directed to systems and methods that can detect and describe image-text misalignment through both textual and visual descriptions. For example, a user can provide a source text string describing a person wearing a red shirt, along with a source image of a person wearing a blue shirt. The system can detect and characterize the mismatch between the text and image by generating an appropriate textual explanation regarding the color discrepancy and also a visual indication (e.g., a bounding box) that identifies specific visual features corresponding to the misalignment.

In particular, in some implementations, a machine-learned misalignment description model can receive and process the source text string and source image to determine whether they properly align. For instance, the model can examine the textual elements such as objects, colors, or actions, and compare them with corresponding visual features in the image. The model can rely on training data that includes both synthetic images and natural photographs.

A beneficial feature of the present disclosure is that the model can generate a textual description describing problems in alignment. For instance, the model can highlight a specific phrase in the text, like “red shirt,” and note that this phrase may not match the image content. The textual description can identify specific misaligned text segments so that users gain clarity on the exact source of the mismatch.

The model can also produce (e.g., sequentially or in parallel) a visual description of the misalignment by creating one or more visual indicators (e.g., bounding boxes) for or in the image. For example, if the text indicates two birds and only one bird is present, the system can locate the single bird using a bounding box. This can help clarify which visual elements do not correspond to the described image content.

The present disclosure can be also extended to multiple misalignments within the same image-text pair. For instance, the source text string might describe a scene with two people, a dog, and a bicycle, while the image might show three people and a cat. The misalignment description model can generate several textual descriptions, one for each discrepancy, and produce multiple bounding boxes to illustrate the various issues.

In some implementations, there can be a correction approach that modifies the text or the image after identifying the misalignments. For example, an alignment correction model can refine the text to remove a mention of the cat if the scene does not contain it. Then, the misalignment description model can reassess the updated version and generate a second textual description if further discrepancies remain.

The present disclosure also describes a method to generate synthetic image-text misalignment training examples and feedback. For instance, a computing system can obtain an image and a set of positive text strings, then use a language model to produce misalignment captions that purposefully introduce incorrect details. This process can enable the creation of large-scale datasets for training misalignment description models.

In some implementations, the system can filter these misalignment captions by applying entailment validation. For example, an entailment model can measure how well the generated misalignment caption contradicts or aligns with the original caption. If the contradiction is too weak or if the explanation lacks clarity, the computing device can discard that misalignment caption to maintain higher-quality training examples.

The target misalignment can arise in object, attribute, action, or spatial relation details. For instance, an attribute misalignment may involve describing a “blue cat” when the image has a “white cat,” whereas a spatial relation misalignment could be describing a person jumping over a fence when the image shows that person standing next to the fence. Training data that captures these various categories can help the misalignment description model cover a broad range of possible discrepancies.

Thus, example implementations of the present disclosure can provide an approach for detecting and/or correcting image-text misalignment by combining textual and visual descriptions. For example, users can deploy this system to evaluate generated images from text-to-image models or verify captions in existing image datasets. The technology can be used to enhance image captioning systems, refine dataset quality, and/or improve the accuracy of generative workflows that rely on aligning text with images.

Another example aspect of the present disclosure is directed to systems and methods for automatic generation of synthetic image-text alignment training examples. In particular, a computing system can obtain an image and one or more positive text strings that describe image content depicted by the image.

In some implementations, the computing system can generate one or more negative text strings that contradict the content of a positive text string. For example, a positive text string describing “a cat lying on a bed” can be processed to produce candidate negative text strings such as “a dog lying on a bed.” These negative text strings can be beneficial for creating challenging training examples that help improve alignment accuracy.

The computing system can store candidate negative text strings alongside the original image to form image-text alignment training examples. For instance, when an image is initially associated with a valid caption, the system can generate and select a suitable contradictory caption. That contradictory caption can then be stored to allow for future training or assessment of a visual-language model.

In some implementations, the system can further retrieve these stored training examples to enable model training. For instance, a visual-language model can be trained or fine-tuned using both positively aligned text strings and negatively aligned text strings. This approach may improve a model's ability to differentiate between accurate depictions and inaccurate or contradictory descriptions of image content.

In some implementations, the computing system can use machine-learned sequence processing models to generate negative text strings. For example, the system can implement a language model that receives instruction data (e.g., store instructions) prompting it to produce contradictory statements. This process can include referencing specific objects or attributes and systematically altering them (e.g., changing “blue cup” to “red cup”) to create variations that are not covered by the original text.

In some implementations, the negative text strings can be validated through a natural language inference model to determine their entailment scores. For example, the system can measure alignment by scoring how contradictory the newly generated text is compared to the original text. The system can then choose the best candidate negative text string for inclusion in the image-text alignment training example based on a threshold or rank of these entailment scores.

Another aspect is directed to techniques for evaluating text-image alignment using visual question answering models. For example, a computing system obtain an input image and an input text string associated with the input image.

The computing system can extract answer spans from the input text string for question generation. For instance, when analyzing a caption like “two puppies sitting on a sofa,” the system can identify key phrases such as “two puppies” and “a sofa” as answer spans. This extraction can help the model generate more focused, accurate questions and/or contradictions about the content of an image.

The computing system can respectively process each answer span and the input text string with a machine-learned question generation model to generate, as an output of the machine-learned question generation model, a respective question text string. For example, the machine-learned question generation model can process the caption “two puppies sitting on a sofa” and the extracted answer span “a sofa” to generate, as an output, a question that asks, “Is a sofa shown in this image?”

In some implementations, a machine-learned visual question answering model can use these derived questions and the input image to generate an alignment score. In an embodiment, the machine-learned misalignment description model can structure the respective question text string and the respective answer span as binary question. For example, the input image and the question “Is a sofa shown in this image?” can be answered with a probability of “yes” or “no,” thereby contributing to a final score that reflects how well the text aligns with the image.

In some implementations, the alignment scores can be aggregated across multiple generated questions to form a single overall metric. For instance, the system can calculate an average of the alignment probabilities for the multiple generated questions. If the average value is above a designated threshold, the image-text pair can be considered aligned. Otherwise, additional scrutiny, such as further question generation or re-checking of candidate negative text strings, can be applied.

Thus, the present disclosure provides a comprehensive framework for processing images and text strings, creating negative text variations, and using machine-learned models to assess semantic accuracy. In some implementations, these capabilities can be leveraged to build robust alignment datasets, train visual-language models, and/or generate alignment scores that help identify specific areas where an image and its text description do not match.

The proposed systems can be used for various tasks. Example tasks include evaluation of the consistency/alignment of image generation tasks. Example tasks include evaluation of image description/Q&A. Example tasks include evaluation of image editing. Example tasks include filtering of data used for the training/evaluation of image-text models.

More particularly, the proposed systems can be used in various applications or services. Example applications include text-to-image (T2I) generation: Online ranking and filtering of generated images based on scores generated by the proposed systems ensures better alignment with user prompts, leading to a significant win in user ratings compared to production behavior. Example applications include T2I adaptation: Integration of the proposed systems into the T2I adaptation pipeline to improve the quality and relevance of generated images. Example applications include image retrieval evaluation: Evaluates the relevance and faithfulness of images retrieved for enriching search results, preventing the inclusion of inaccurate or misleading information. Example applications include multimodal evaluation: Provides a valuable signal for evaluating diverse cases of image inputs and outputs, contributing to improved model performance and user experience.

The systems and methods of the present disclosure provide a number of technical effects and benefits. As one example, by employing a single machine-learned model to produce both textual and visual descriptions of misalignments, the system avoids the duplication of computations and data processing routines that would otherwise arise from separately invoking multiple models. For example, a single model can load shared parameters once and reuse intermediate features for generating bounding boxes and generating explanatory text, improving memory usage and decreasing inference time. This provides an efficient solution that lessens demands on network and hardware resources.

As another example, the proposed techniques for automatically generating training examples can improve model performance by providing a more diverse and comprehensive set of data representations, which may help address gaps or biases in the original training set. For example, when a computing system automatically generates negative text strings or contradictory captions, the resulting training data can better represent real-world complexities and nuances in image-text alignment tasks. In some implementations, models trained on this enriched dataset can more accurately distinguish between correct and incorrect image-text pairs, enhancing their ability to handle subtle object, attribute, or spatial misalignments during inference.

Various example implementations are described herein with respect to the accompanying Figures.

### Example Approaches for Generating Textual and Visual Descriptions of Image-Text Misalignments

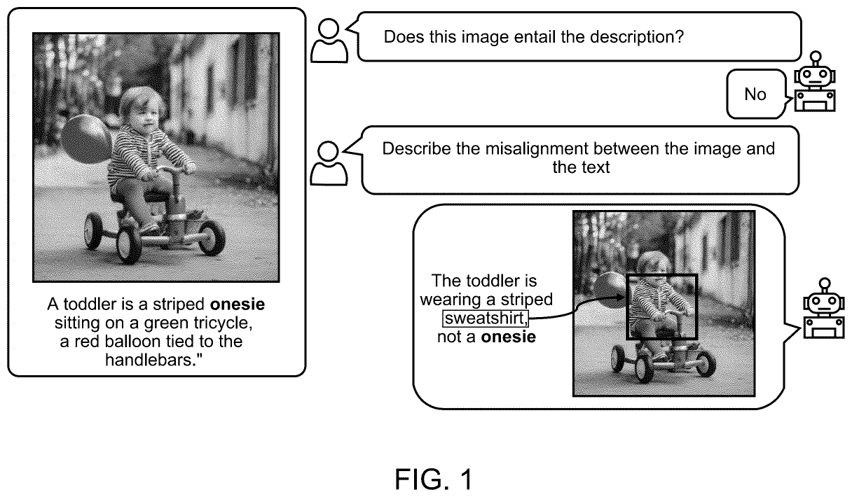

Contrast Generation Feedback (ConGen-Feedback) is a method that can be used to generate plausible contradicting captions for image-text misalignments including textual and visual explanations of the misalignments. The method can generate textual and visual descriptions of the misalignments at various granularities: word, paragraph, sentence, and full image. The textual and visual descriptions can include explanations of the misalignments, e.g., “misalignments based on object, attribute, relationship, action, etc.”, and textual and visual cues about where the misalignments occur “on the vehicle, on the windshield, on the road.” This can be done by employing the capabilities of large language models (LLMs) and visual grounding models. For example, a machine-learned misalignment description model can be trained with an automatically generated textual and visual feedback (TV Feedback) dataset, to predict the alignment label and to generate feedback for misaligned image and text pairs. FIG. 1 depicts a misalignment description process for generating a textual description and a visual description of a image-text misalignment according to example embodiments of the present disclosure. This description process can introduce a feedback mechanism for image-text pair generation so that the machine-learned misalignment description model can not only score but also describe and visually annotate discrepancies between images and text.

As shown in FIG. 1, a single model (e.g., a machine-learned misalignment description model) can be used to determine if an image corresponds to a given text string, output an alignment score to represent the likelihood of a “yes” answer (e.g., the image matches the text), or a “no” answer (e.g., the image does not match the text), and provide a textual summary of discrepancies between the image and the text, identification of misaligned text segments, and image visual misalignments, marked by bounding boxes.

In particular, the machine-learned misalignment description model can obtain a source text string and a source image. The source text string and the image may be misaligned. As shown in FIG. 1, the misalignment may be that a toddler is described in the text string as being “in a striped onesie” while shown in the corresponding image to be “wearing a striped sweatshirt, not a onesie.” The machine-learned misalignment description model can be prompted with a query to determine if an image corresponds to a given text string. For example, the machine-learned misalignment description model can be prompted with “Does this image entail the description?” The expected response format can be “<misalignment in image (bounding box)>” aiming to extract detailed feedback and specific misalignment indicators in a single model interaction.

In some embodiments, the machine-learned misalignment description model can utilize a two-step approach. First, the machine-learned misalignment description model can generate a generated textual misalignment description. Next, the machine-learned misalignment description model can process the generated textual misalignment description and employ a pre-trained model, such as GroundingDINO, to extract bounding-box information and generate a bounding box to visually represent the image-text misalignment.

### Example Approaches for Iteratively Correcting Image-Text Misalignments

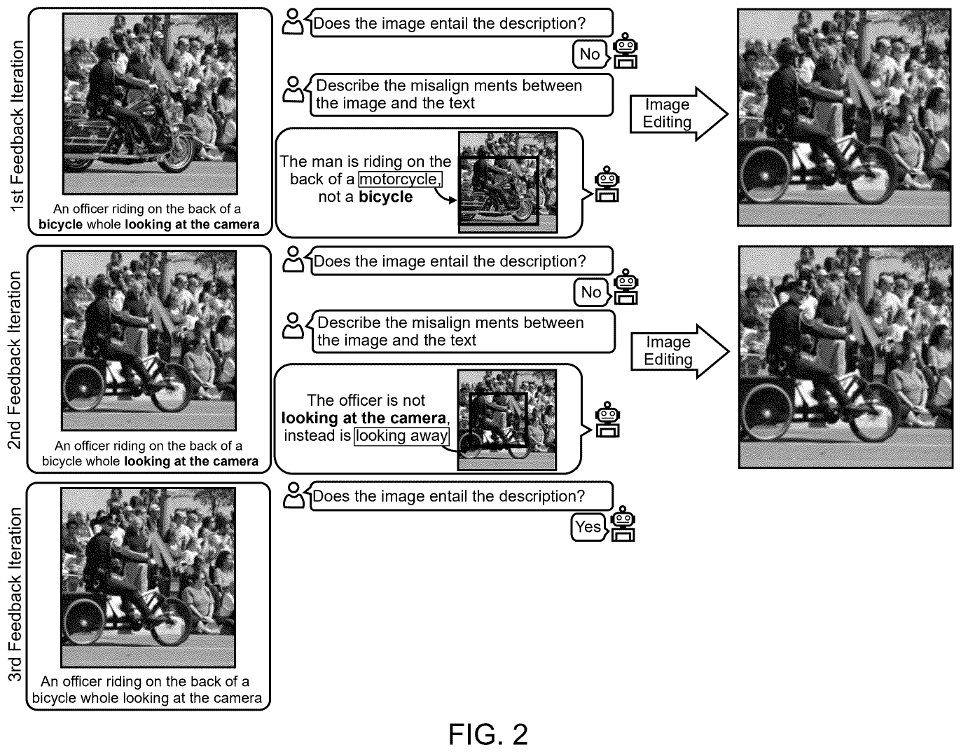

FIG. 2 depicts an iterative misalignment correction process for generating and fixing sequential image-text misalignments according to example embodiments of the present disclosure. As shown in FIG. 2, the machine-learned misalignment description model can obtain a source text string and a source image. The source text string and the source image may be misaligned. In some embodiments, the source text string and the source image may include multiple misalignments.

For example, the text string may recite “an officer riding on the back of a bicycle while looking at the camera. As part of a first feedback iteration, the machine-learned misalignment description model can be prompted with a query to determine if an image corresponds to a given text string. If the machine-learned misalignment description model determines that the answer is “no” (e.g., the image does not entail the text string), the machine-learned misalignment description model can be prompted to generate a textual misalignment description and a visual misalignment description. For example, the machine-learned misalignment description model can describe that “the man is riding on the back of a motorcycle, not a bicycle.” The machine-learned misalignment description model can also generate visual feedback, such as a bounding box, to identify the misalignment. A first image editing process may occur based on the feedback from the machine-learned misalignment description model. The edited image can be used in conjunction with the source text string as an input to the machine-learned misalignment description model during a second feedback iteration.

The second feedback iteration can repeat the same process as above. For example, the machine-learned misalignment description model can be queried to determine if an image corresponds to a given text string, the machine-learned misalignment description model can respond with “yes” or “no,” and the machine-learned misalignment description model can generate a textual misalignment description and a visual misalignment description in the case of a “no.” For example, the machine-learned misalignment description model can describe that “the officer is not looking at the camera, instead is looking away.” The machine-learned misalignment description model can also generate visual feedback, such as a bounding box, to identify the misalignment. A second image editing process may occur based on the latest feedback from the machine-learned misalignment description model. The twice edited image can be used in conjunction with the source text string as an input to the machine-learned misalignment description model during a third feedback iteration. This process may continue for as many iterations as required, until the machine-learned misalignment description model determines that the image entails the description, for example, by generating a “yes” in response to the query.

### Example Approaches for Automatically Generating Synthetic Image-Text Misalignment Training Examples and Feedback

To train the machine-learned misalignment description model, a training dataset can be generated, (e.g., TV Feedback). For example, a training dataset can include known misaligned image-text pairs, along with ground truth misalignment labels. In some embodiments, the generated TV Feedback dataset can be used to train the machine-learned misalignment description model, (e.g., ConGen-Feedback Model).

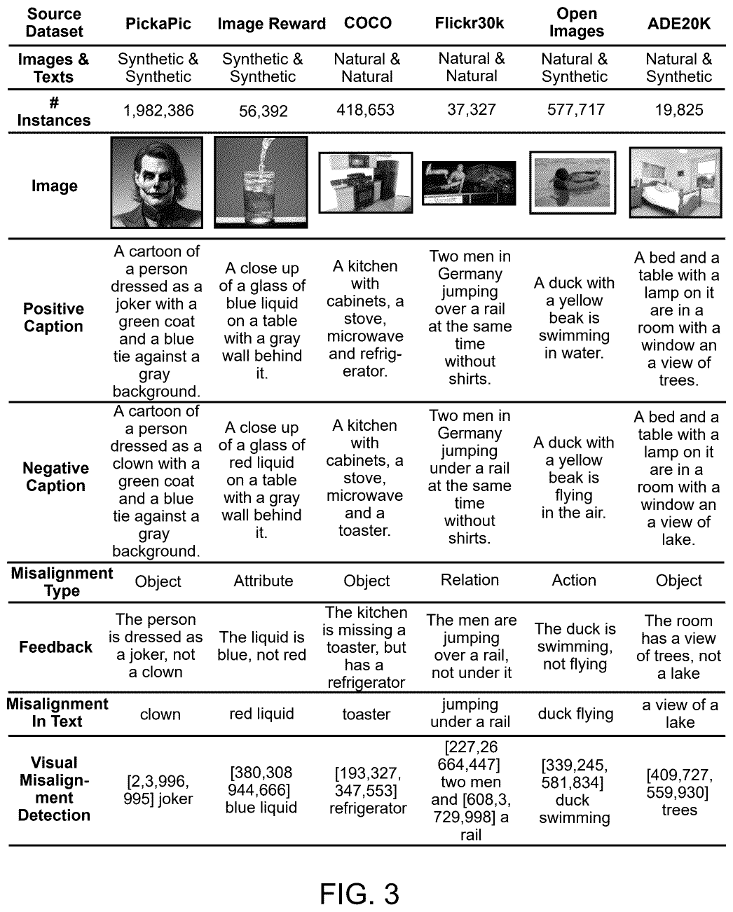

FIG. 3 depicts an automatically generated synthetic image-text misalignment training dataset according to example embodiments of the present disclosure. The generation of the synthetic image-text misalignment training example dataset can begin with collecting positive image-text pairs. These positive image-text pairs can be collected from a variety of known databases, such as PickaPic, ImageReward, COCO, Flickr30k, Open Images, and ADE20k, amongst others. The collected image text pairs can include real images and synthetic images. The image captions can be generated by human-annotation, or automatically generated by a LLM model. In some cases, images are already available for each image, and the longest may be taken from the several options available to increase textual richness. In some embodiments, while captions may not exist for the images, there may be alternative text strings stored in conjunction with the images. For example, the images in some known databases may include localized narratives, such as detailed point-of-view annotations. These localized narratives may be transformed into more conventional positive captions (e.g., accurately representing the image) by rewriting the narrative into standardized captions with a few-shot prompt on a pre-trained LLM, such as PaLM 2. In other words, the images can be processed with a machine-learned caption generation model to generate, as an output of the machine-learned caption generation model, at least one of the one or more positive text strings.

The generation of the synthetic image-text misalignment training example dataset can continue by generating misaligned image-text pairs and feedback. For example, for each positive image-text pair, a negative example including misaligned captions and relevant feedback can be generated. In some embodiments, this can first include, for each aligned image-text pair, tagging the caption for the specific part of speech tags, such as with a pre-trained model like spaCy. After tagging, the generated misaligned image-text pairs can be categorized into misalignment categories. For example, some misalignment categories can include object misalignment, attribute misalignment, action misalignment, and spatial relation misalignment. In some embodiments, to ensure a balanced representation, the negative generated image-text pairs can be sampled equally from each of the misalignment categories.

The generation of the synthetic image-text misalignment training example dataset can continue by, for each image-text pair, generating a contradiction caption that introduces the target misalignment, a detailed explanation of the contradiction, a misalignment cue that pinpoints the contradictory element in the caption, and a label for the visual bounding box to be placed in the image, for example, with a pretrained LLM utilizing a few-shot prompt (e.g., PaLM 2 API). In some embodiments, there may be multiple generated or stored captions for the same image. Accordingly, in some embodiments, the process can include taking a caption as an input and instructing an LLM to generate variants that contradict it. In some embodiments, an NLI model can be used to select the variant with the lowest entailment score.

The generation of the synthetic image-text misalignment training example dataset can continue by filtering out examples based on an entailment validation. For example, textual entailment models can classify whether a hypothesis text is entailed by a premise text, to indicate the degree of semantic alignment. In some embodiments, two entailment scores may be used, a first entailment score to determine whether the generated contradiction caption adequately contradicts the original one (e.g., a Contradiction Correctness (CC)) and a second entailment score to check whether the generated feedback accurately explains the misalignment between the original (aligned) image caption and the generated contradiction caption (e.g., a Feedback Correctness (FC)). For example, the CC can have an input including the original (positive) caption as the premise and the generated contradiction as the hypothesis. The goal may be to have a low entailment score, indicating that the negative caption truly differs from the original caption. In other words, filtering negative captions can include providing a respective entailment score for each candidate negative text string. For example, the FC can have an input including the original (positive) caption along with the generated contradiction as the premise, and the generated feedback as the hypothesis. The goal may be to have a high entailment score, indicating that the feedback remarks the misalignment between the original caption and the generated contradiction. In other words, evaluating, by the textual entailment model, the one or more positive text strings can include utilizing a contradiction correction premise and a misalignment caption as a contradiction correction hypothesis to determine a contradiction correctness level. In other words, evaluating, by the textual entailment model, the one or more positive text strings can utilize the misalignment caption as a feedback correctness premise, and a generated feedback as a feedback correctness hypothesis to determine a feedback correctness level.

In some embodiments, data may be filtered out from the initial dataset based on their evaluation, such as by their CC and FC scores. In some embodiments, samples with a CC score higher than about 0.2 to about 0.3 may be filtered out. In some embodiments, samples with a FC score lower than about 0.7 to about 0.8 may be filtered out. For example, samples with a CC score higher than about 0.25 and samples with a FC score lower than about 0.75 may be filtered out. In an embodiment, one or more remaining misalignment captions can be stored for use in the TV feedback dataset after filtering.

The generation of the synthetic image-text misalignment training example dataset can continue by annotating visual feedback for the remaining samples after the filtering based on the entailment validation. For example, textual labels can be taken to place a bounding box around the corresponding element in the image. For example, a pretrained visual grounding model such as GroundingDINO can be used. Alternatively, object detection models could be used to generate bounding boxes. In some embodiments, to ensure consistent representation for different images, the bounding box coordinates can be stored as a normalized range between about 0 and about 1000.

In some embodiments, an example method for automatically generating synthetic image-text misalignment training examples and feedback can include obtaining, by a computing system comprising one or more computing devices, an image and one or more positive text strings that describe image content depicted by the image. The method can include defining, by the computing system, one or more misalignment categories. The method can include generating, with a pre-trained large language model, one or more misalignment captions that introduce a target misalignment. The one or more misalignment captions can include a detailed explanation of the target misalignment and a misalignment cue that pinpoints a misaligned element in the one or more misalignment captions. The method can include generating, with the pre-trained large language model, a visual bounding box label for the image corresponding to the one or more misalignment captions.

### Example Approaches for a Comprehensive Text-Image Alignment Benchmark

There are shortcomings in current benchmarks for text-image alignment evaluation systems. For example, existing benchmarks mainly focus on natural images and often lack challenging negative captions. The text-image alignment benchmark dataset (SeeTRUE benchmark) can be a more diverse benchmark for meta-evaluation of image-text alignment methods, covering all four combinations of real and synthetic text-image pairs (e.g., real text+real image, real text+synthetic image, synthetic text+real image, synthetic text+synthetic image).

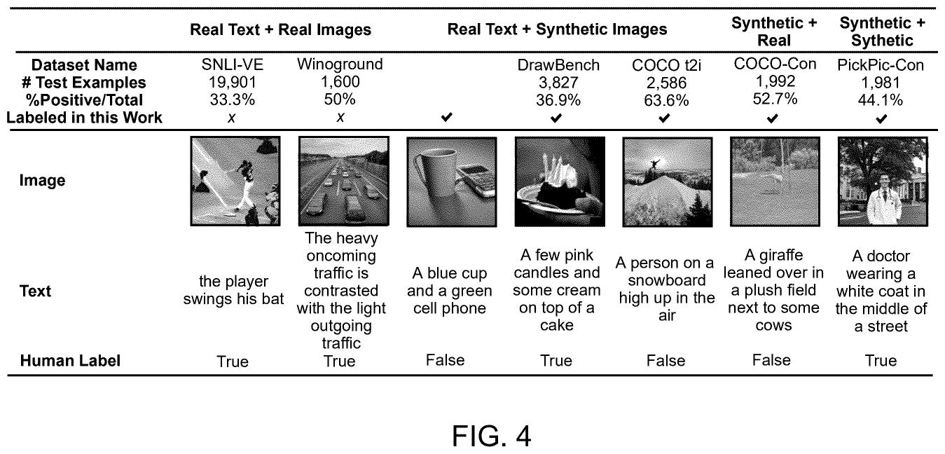

FIG. 4 is a chart that depicts a comprehensive text-image alignment benchmark dataset according to example embodiments of the present disclosure. The dataset can include real text and real images. In some embodiments, the dataset can include pairs of human-written text and real (non-generated) images, such as from SNLI-VE and Winoground datasets. For example, the dataset can include an image of a baseball player swinging his bat, along with a corresponding text “the player swings his bat” or an image of traffic, along with the text “the heavy oncoming traffic is contrasted with the light outgoing traffic.” In some embodiments, the dataset can include human labels for these matches, listing them as true or false. For example, each of these examples can be labelled as true.

The dataset can include real text and synthetic images. In some embodiments, the dataset can include pairs of human-written text and synthetic (generated) images, such as from EditBench. For example, the dataset can include an image of a green cup and a blue cell phone, with corresponding text “a blue cup and a green cell phone.” In some embodiments, the dataset can include human labels for this match, listing it as false.

The dataset can include synthetic text and real images. In some embodiments, the dataset can include pairs of generated text and real (non-generated) images, such as from COCO-Con. For example, the dataset can include an image of a giraffe with corresponding text “a giraffe leaned over in a plush field next to some cows.” In some embodiments, the dataset can include human labels for this match, listing it as false.

The dataset can include synthetic text and synthetic images. In some embodiments, the dataset can include pairs of generated text and synthetic (generated) images, such as from PickaPic. For example, an image can include a doctor wearing a white coat in the middle of the street, with corresponding text “a doctor wearing a white coat in the middle of a street.” In some embodiments, the dataset can include human labels for this match, listing it as true. In some embodiments, the pairs of synthetic text real images and synthetic text synthetic image pairs can be generated by an automatic contradiction generation method.

In some embodiments, standardized labeling can be utilized, such as binary annotations for alignment and misalignment. To standardize the labelling scheme across datasets for the SeeTRUE benchmark, binary annotations for alignment and misalignment can be used. For example, in datasets with three-way annotations (e.g., entailment, contradiction, neutral) a binary annotation can be used, such as collapsing all non-entailment and non-alignment labels into a single negative label. In some embodiments, automatically generated labels can be used. In some embodiments, human annotation can be used separately or in conjunction with automatically generated labels.

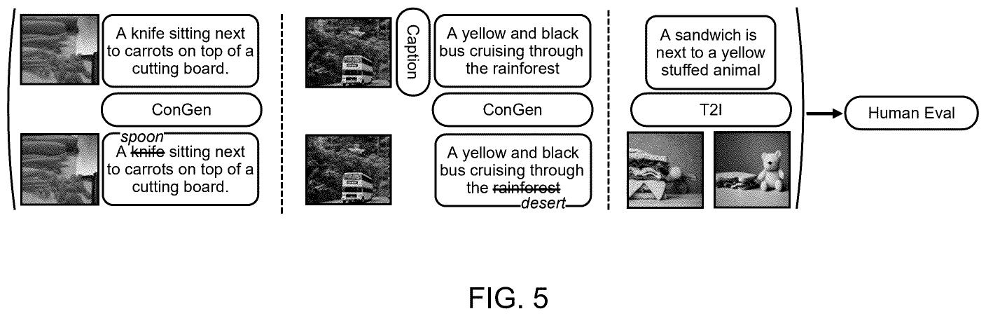

FIG. 5 is a graphical diagram of the SeeTRUE benchmark generation process according to example embodiments of the present disclosure. The process can include an image-text pair from a dataset being used to generate a contradicting caption using ConGen. For example, an image-text pair can show an image of a knife sitting next to carrots on top of a cutting board, and its corresponding text “a knife sitting next to carrots on top of a cutting board.” In some embodiments, the ConGen model can generate a contradicting caption such as “a spoon sitting next to carrots on top of a cutting board.”

The process can include an image (real or synthetic) being passed through a captioning model to generate a caption, which can then be passed to ConGen to generate a contradicting caption. For example, an image can include a yellow and black bus cruising through the rainforest with corresponding text “a yellow and black bus cruising through the rainforest.” In some embodiments, the ConGen model can generate a contradicting caption such as “a yellow and black bus cruising through the desert.” The process can include a text-to-image model being applied on captions from the dataset to create multiple image-text pairs. For example, a text can include “a sandwich is next to a yellow stuffed animal.” In some embodiments, a text-to-image model can be applied to this caption to generate one or more images corresponding to the text. The process of generating the SeeTRUE benchmark dataset can include all the resulting examples being evaluated by human raters to create SeeTRUE.

In some embodiments, there may be a way to generate multiple unaligned captions from existing aligned image-text pairs and select the minimally perturbed example caption. Accordingly, in some embodiments, the process can include taking a caption as an input and instructing an LLM to generate variants that contradict it. For example, an LLM can be instructed to generate several contradiction captions via few-shot inference with positive and negative examples. In some embodiments, an natural language inference (NLI) model can be used to select the variant with the lowest entailment score.

### Example Approaches for Generating an Alignment Score (VQ\hat{ }2)

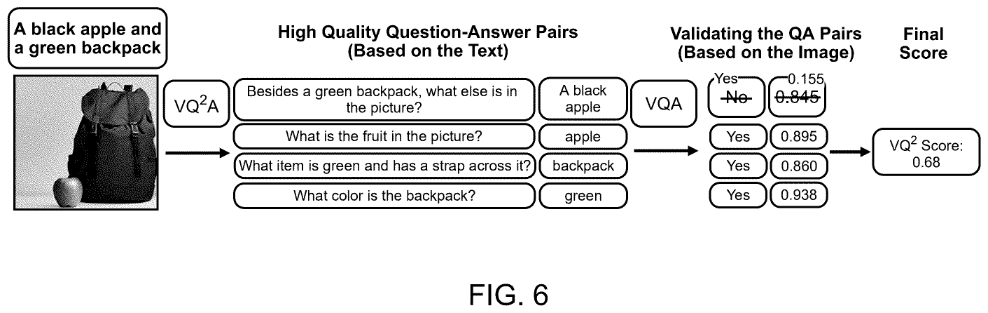

FIG. 6 is a graphical diagram that depicts an example method for generating an alignment score according to example embodiments of the present disclosure. For example, an alignment score can be generated by a zero-shot approach for automatically evaluating image-text alignment based on question generation and question answering. In some embodiments, for a given image-text pair, a set of candidate answer spans can be extracted from the given text, such as by a pre-trained LLM. For example, as shown in FIG. 6, candidate answer spans can be “a black apple”, “apple”, “backpack”, and “green” for the given image. In some embodiments, a question generation model can be used to generate a question for each answer candidate. For example, as shown in FIG. 6, a question can be “besides a green backpack, what else is in the picture” for one of the answer spans (e.g., “a black apple”). For example, as shown in FIG. 6, a question can be “what is the fruit in the picture?” for one of the answer spans (e.g., “apple”). For example, as shown in FIG. 6, a question can be “what item is green and has a strap across it?” for one of the answer spans (e.g., “backpack”). For example, as shown in FIG. 6, a question can be “what color is the backpack?” for one of the answer spans (e.g., “green”).

In some embodiments, each generated question-answer pair can be scored with a question answering model, for example, by a pre-trained LLM (e.g., the machine-learned misalignment description model). In some embodiments, if the question answering model returns a low score, such as a score that does not satisfy a threshold, the corresponding question answer pair can be filtered out, resulting in a subset of question answer pairs. In other words, the machine-learned misalignment description model can determine answer scores for each corresponding answer span. In some embodiments, each generated question-answer pair can be independently validated based on the image using the machine-learned misalignment description model to obtain an alignment score. For example, the overall alignment score (denotated as VQ\hat{ }2) for an image-text pair can be the average of all alignment scores for all the generated question answer pairs for that image.

### Generating Question-Answer Pairs

Question-answer pairs can be generated for an image-text pair, for example, by extracting answer spans from text using a pretrained LLM (such as SpaCy) based on Part-of-Speech (POS) and dependency parse tree annotations. In some embodiments, for each answer span, a question can be generated given the answer span and the full caption as input using a fine tuned LLM model (such as a T5-XXL model fine-tuned on SQuAD1). In some embodiments, each candidate question-answer pair can be validated by answering each generated question using a question answering model (such as a T5-XXL model fine-tuned on SQuAD2.0 and Natural Questions). In some embodiments, the output answer can be matched to the expected answer using token-level F1 comparison. In some embodiments, filtering can be performed on question-answer pairs if the F1 score is lower than a threshold, such as about 0.5 to about 0.6 (e.g., 0.54).

Assessing Question-Answer Pair Alignment Against the Image To determine if the information conveyed by the text is presented correctly in the image, a VQA model can be used to reformulate the question and answer pair into a yes-no predicate question (such as “is true for in this image?”). For example, for the text “two girls are sitting on some grass” and an automatically induced question-answer pair {“what are the girls sitting on?”, “on some grass” }, the reformulated question can be “is on some grass true for what are the girls sitting on in this image?” In some embodiments, the VQA model can answer the yes-no predicate question with respect to the image. In some embodiments, the alignment score can be the probability of the model answering “yes.” In other words, determining the answer score for a respective answer span can include determining the respective answer score as a probability of the machine-learned visual question answering model providing a positive binary output.

### Example Approaches for Generating an Alignment Score (VNLI)

In some embodiments, an end-to-end Visual NLI model (VNLI) can receive an image and text as input, and directly predict an alignment score. For example, a multimodal pretrained model can be fine-tuned while formatting the examples as yes-no questions using a prompt such as “does this image entail the description: ?”, followed by a binary “yes” or “no” answer. In some embodiments, the probability of predicting “yes” or “no” can be used as a relative ratio to calculate an alignment score. For example, a finetuned BLIP2 and PaLI-17B model can be utilized with a dataset comprising about 110,000 text-image pairs labeled with alignment annotations.

### Example Devices and Systems

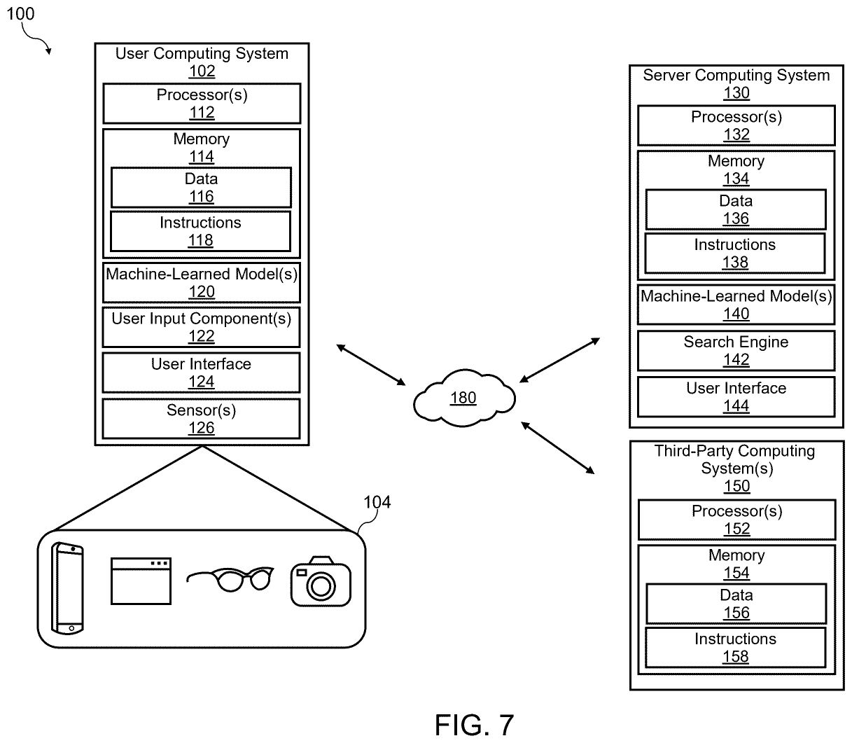

FIG. 7 depicts a block diagram of an example computing system 100 that performs information retrieval according to example embodiments of the present disclosure. The system 100 includes a user computing system 102, a server computing system 130, and/or a third computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display). The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 5B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

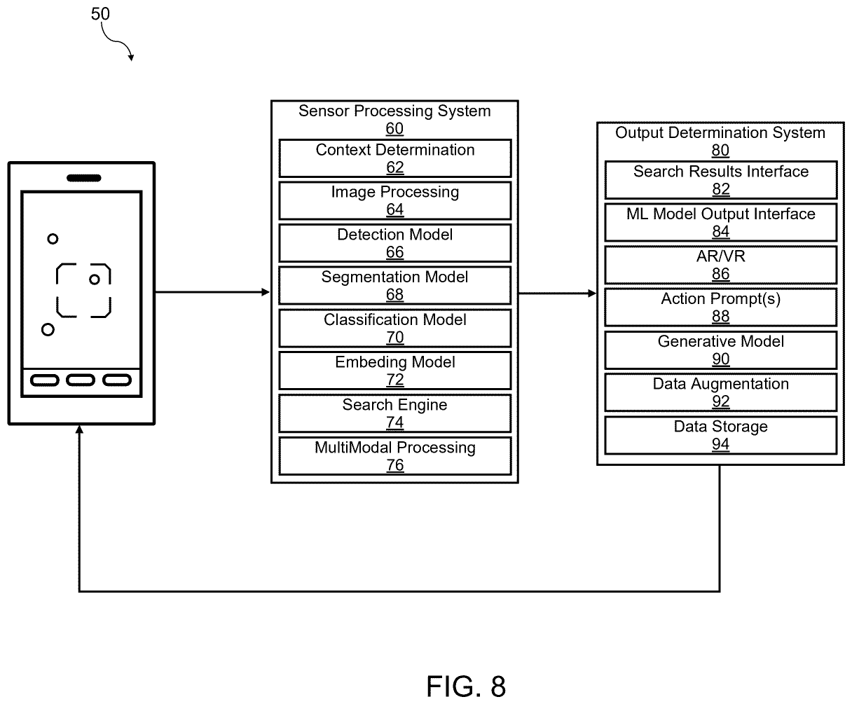

FIG. 8 depicts a block diagram of an example computing system 50 that performs information retrieval according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

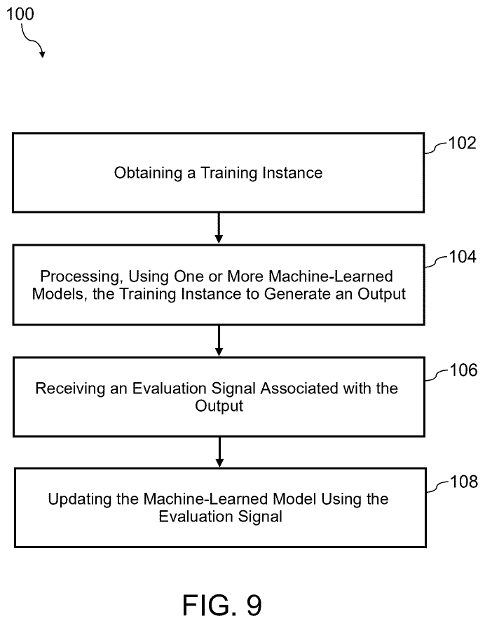

FIG. 9 depicts a flowchart of a method 100 for training one or more machine-learned models according to aspects of the present disclosure. For instance, an example machine-learned model can include a vision language model. A vision language model can be or include a sequence processing model.

One or more portion(s) of example method 100 can be implemented by a computing system that includes one or more computing devices such as, for example, computing systems described with reference to the other figures. Each respective portion of example method 100 can be performed by any (or any combination) of one or more computing devices. Moreover, one or more portion(s) of example method 100 can be implemented on the hardware components of the device(s) described herein, for example, to train one or more systems or models. FIG. 1 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 1 is described with reference to elements/terms described with respect to other systems and figures for exemplary illustrated purposes and is not meant to be limiting. One or more portions of example method 100 can be performed additionally, or alternatively, by other systems.

At 102, example method 100 can include obtaining a training instance. A set of training data can include a plurality of training instances divided between multiple datasets (e.g., a training dataset, a validation dataset, or testing dataset). A training instance can be labeled or unlabeled. Although referred to in example method 100 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 104, example method 100 can include processing, using one or more machine-learned models, the training instance to generate an output. The output can be directly obtained from the one or more machine-learned models or can be a downstream result of a chain of processing operations that includes an output of the one or more machine-learned models.

At 106, example method 100 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 108, example method 100 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 100 can include implementing a number of generalization techniques (e.g., weight decays, dropouts, etc.) to improve the generalization capability of the models being trained.

In some implementations, example method 100 can be implemented for training a machine-learned model from an initialized state to a fully trained state (e.g., when the model exhibits a desired performance profile, such as based on accuracy, precision, recall, etc.).

In some implementations, example method 100 can be implemented for particular stages of a training procedure. For instance, in some implementations, example method 100 can be implemented for pre-training a machine-learned model. Pre-training can include, for instance, large-scale training over potentially noisy data to achieve a broad base of performance levels across a variety of tasks/data types.

In some implementations, example method 100 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 100 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 100 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

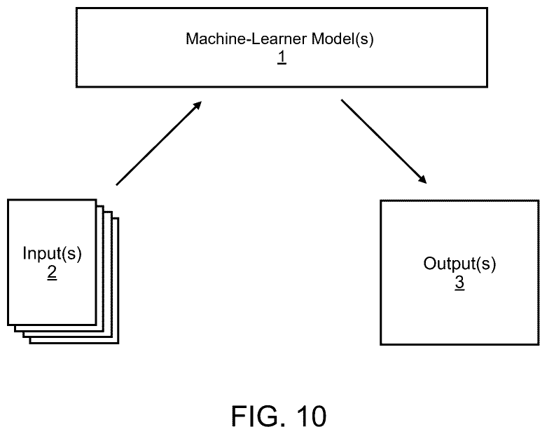

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the models described herein. Although various features, variations, and implementations described below are described with respect to machine-learned model(s) 1, it is to be understood that such features, variations, and implementations are to be understood as described with respect to each of models described herein, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

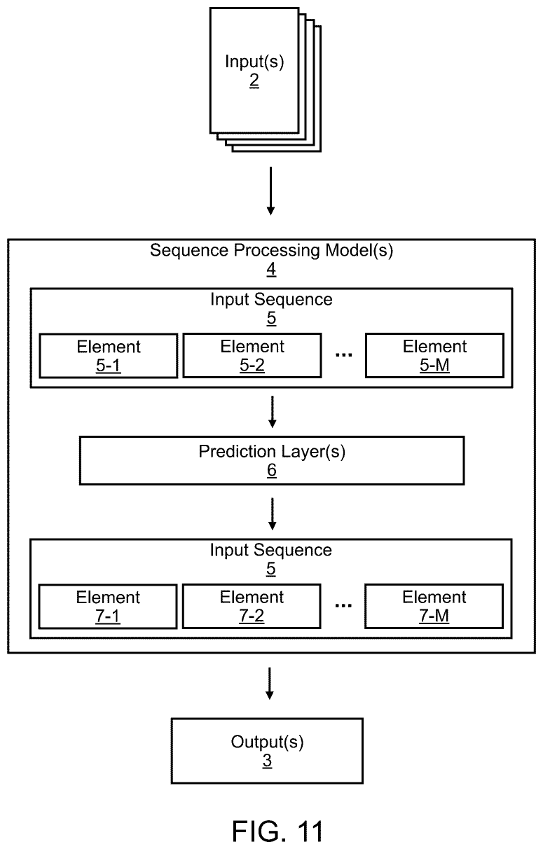

FIG. 11 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 3 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

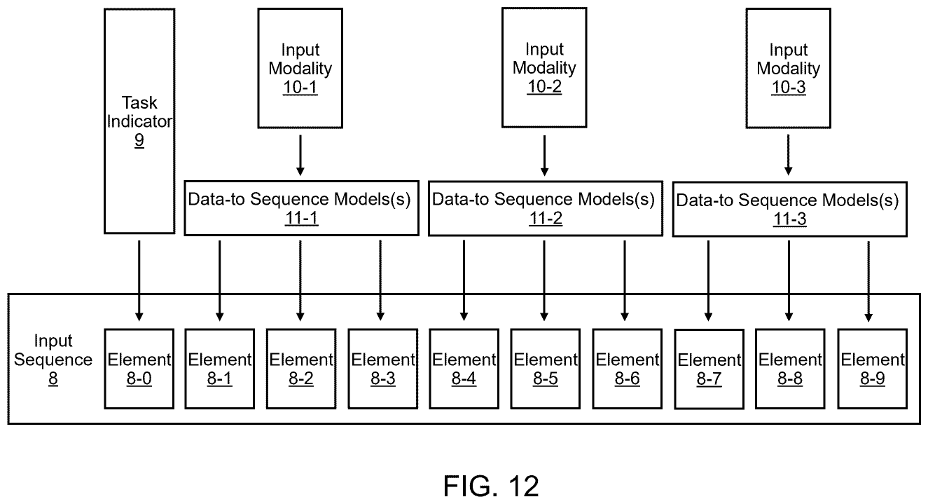

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

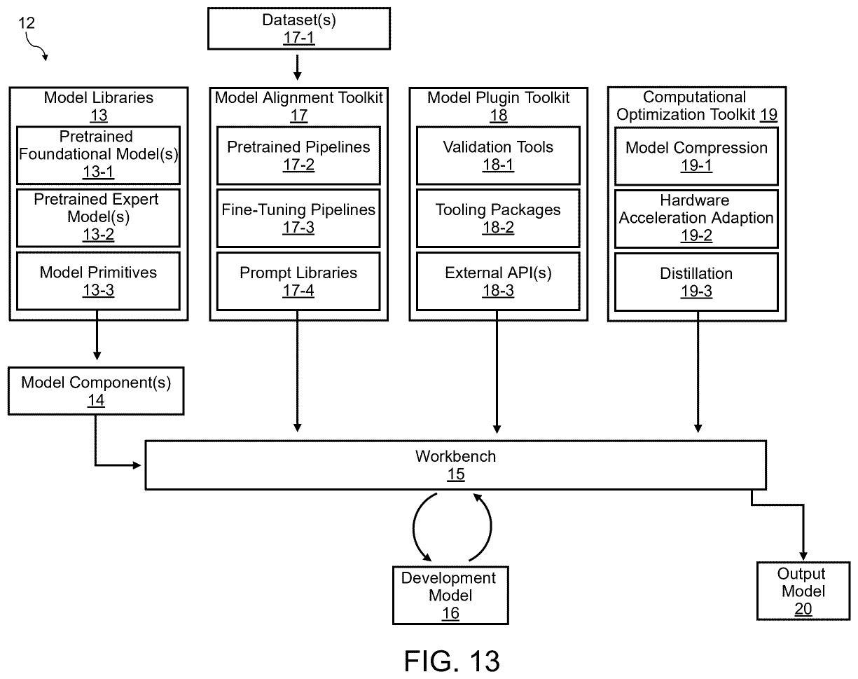

FIG. 13 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 100 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

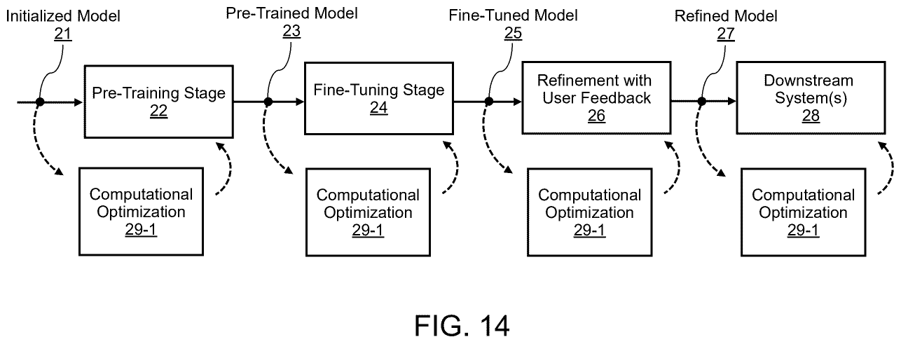

FIG. 14 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

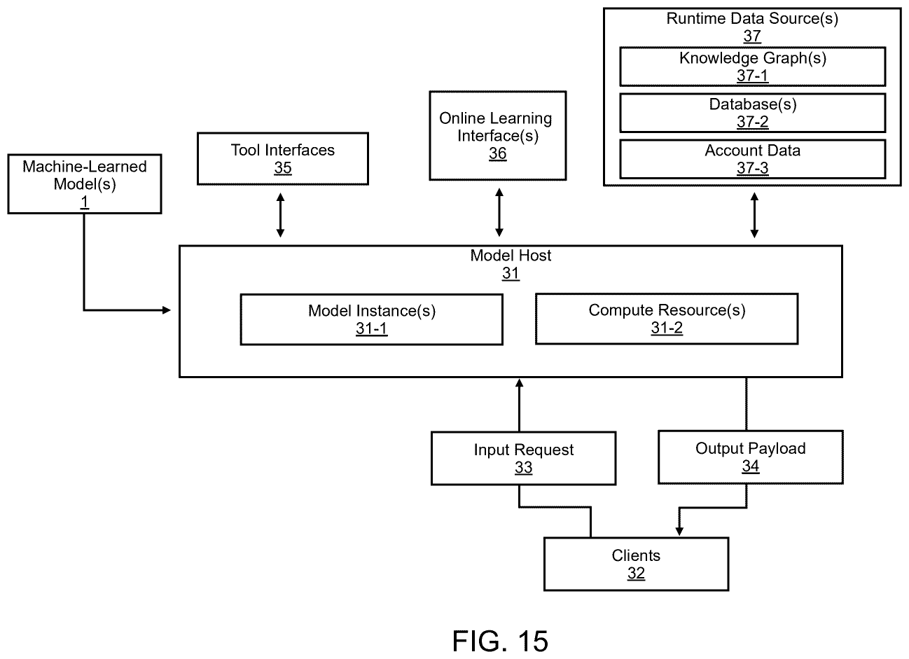

FIG. 15 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

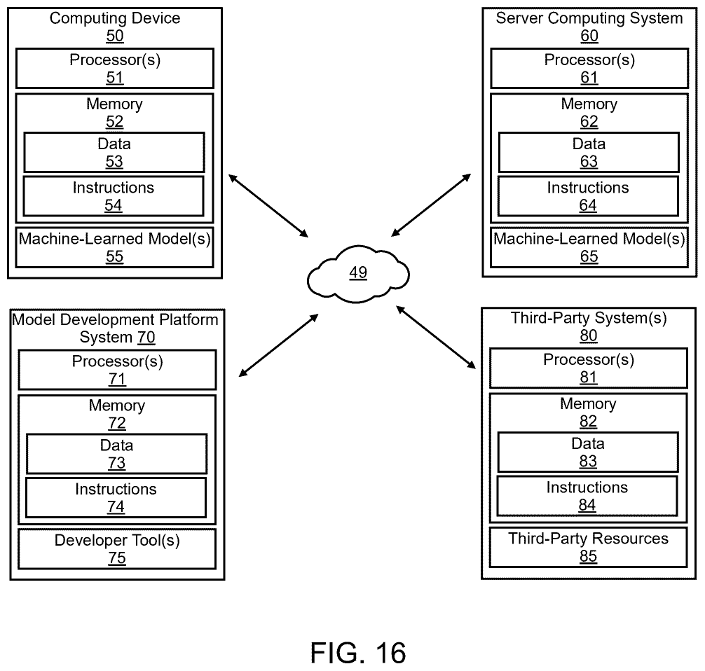

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 8 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 8 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

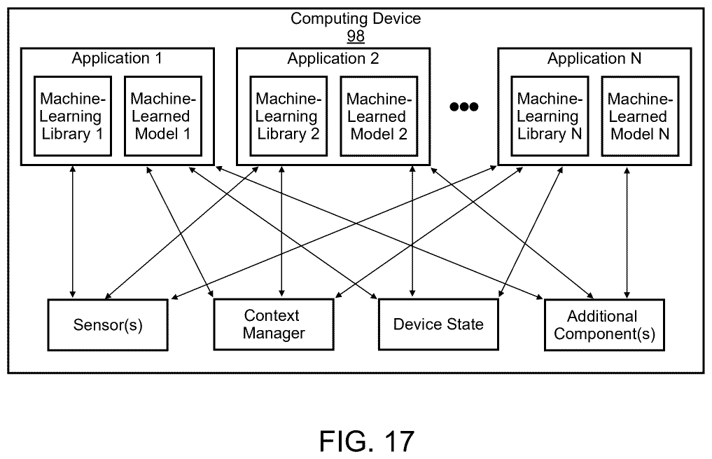

FIG. 17 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 9, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

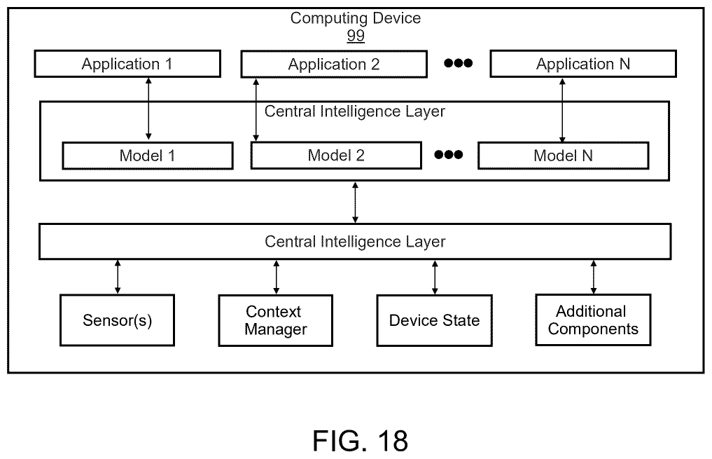

FIG. 18 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 10, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 10, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer system for analysis of image-text misalignment, the computer system comprising:
one or more processors; and
one or more non-transitory computer-readable media that collectively store:
a machine-learned misalignment description model configured to receive and process a source text string and a source image to generate both (i) a textual description of an image-text misalignment between the source text string and the source image and (ii) a visual description of an image-text misalignment between the source text string and the source image;
wherein the textual description comprises identification of one or more misaligned text segments that correspond to the image-text misalignment between the source text string and the source image; and
the visual description identifies one or more visual elements that correspond to the image-text misalignment between the source text string and the source image.

2. The computer system of claim 1, wherein the machine-learned misalignment description model is also further configured to compare the source text string to the source image and generate a first alignment score.

3. The computer system of claim 1, wherein the visual description comprises one or more bounding boxes.

4. The computer system of claim 3, wherein the misalignment description model generates the visual description of the image-text misalignment by:
receiving the textual description of the image-text misalignment, and
generating the one or more bounding boxes based on the textual description of the image-text misalignment.

5. The computer system of claim 1, wherein the misalignment description model is configured to generate a second textual description of a second misalignment between the source text string and the source image, and the misalignment description model is configured to generate a second visual description of the second misalignment.

6. The computer system of claim 5, further comprising an alignment correction model configured to correct the image-text misalignment before the misalignment description model generates the second textual description of the second misalignment.

7. A computer-implemented method for automatic generation of synthetic image-text misalignment training examples and feedback, the method comprising:
obtaining, by a computing system comprising one or more computing devices, an image and one or more positive text strings that describe image content depicted by the image;
generating, with a language model, one or more misalignment captions that introduce a target misalignment, the one or more misalignment captions including an explanation of the target misalignment and a misalignment cue that specifies a misaligned element in the one or more misalignment captions; and
generating, with a visual grounding model, a visual bounding box label for the image corresponding to the one or more misalignment captions.

8. The computer-implemented method of claim 7, further comprising:
filtering, by the computing system, the one or more misalignment captions with entailment validation; and
storing, by the computing system, one or more remaining misalignment captions.

9. The computer-implemented method of claim 8, wherein filtering the one or more misalignment captions with entailment validation comprises:
evaluating, by an entailment model, the one or more positive text strings as a contradiction correction premise and the misalignment caption as a contradiction correction hypothesis, to determine a contradiction correctness level;
evaluating, by the entailment model, the one or more positive text strings and the misalignment caption as a feedback correctness premise, and a generated feedback as a feedback correctness hypothesis, to determine a feedback correctness level; and
removing, by the computing device, the one or more misalignment captions from the synthetic image-text misalignment training examples and feedback if either the contradiction correctness level or the feedback correctness level fail to satisfy a threshold.

10. The computer-implemented method of claim 7, wherein the target misalignment comprises an object misalignment, an attribute misalignment, an action misalignment, and a spatial relation misalignment.

11. A computer-implemented method for automatic generation of synthetic image-text alignment training examples, the method comprising:
obtaining, by a computing system comprising one or more computing devices, an image and one or more positive text strings that describe image content depicted by the image;
processing, by the computing system, at least one of the one or more positive text strings with a machine-learned sequence processing model to generate, as an output of the machine-learned sequence processing model, one or more candidate negative text strings that each contradict at least one of the one or more positive text strings; and
storing, by the computing system, at least one of the candidate negative text strings together with the image as an image-text alignment training example.

12. The computer-implemented method of claim 11, further comprising:
retrieving, by the computing system, the image-text alignment training example from memory; and
training, by the computing system, a visual-language model on the image-text alignment training example.

13. The computer-implemented method of claim 11, wherein obtaining, by the computing system, the image and the one or more positive text strings comprises:
obtaining, by the computing system, the image; and
processing, by the computing system, the image with a machine-learned caption generation model to generate, as an output of the machine-learned caption generation model, at least one of the one or more positive text strings.

14. The computer-implemented method of claim 11, wherein processing, by the computing system, at least one of the one or more positive text strings with the machine-learned sequence processing model comprises processing, by the computing system, the at least one of the one or more positive text strings with the machine-learned sequence processing model while conditioning the machine-learned sequence processing model with instruction data, wherein the instruction data instructs the machine-learned sequence processing model to provide a caption that contradicts the at least one of the one or more positive text strings.

15. The computer-implemented method of claim 11, wherein:
the one or more positive text strings comprise a plurality of positive text strings; and
processing, by the computing system, at least one of the one or more positive text strings with the machine-learned sequence processing model comprises processing, by the computing system, the plurality of positive text strings with the machine-learned sequence processing model while conditioning the machine-learned sequence processing model with instruction data, wherein the instruction data instructs the machine-learned sequence processing model to provide a caption that contradicts all of the plurality of positive text strings.

16. The computer-implemented method of claim 11, wherein:
the one or more candidate negative text strings comprise a plurality of candidate negative text strings; and
the method further comprises:
respectively processing, by the computing system, each candidate negative text string and the image with a natural language inference model to generate, as an output of the natural language inference model, a respective entailment score for each candidate negative text string;
selecting, by the computing system, the at least one of the candidate negative text strings for inclusion in the image-text alignment training example based on the respective entailment score generated for each candidate negative text string.

17. The computer-implemented method of claim 11, wherein the machine-learned sequence processing model comprises a language model.

18. One or more non-transitory computer-readable media that collectively store instructions that, when executed by a computing system comprising one or more computing devices, cause the computing system to perform operations, the operations comprising:
obtaining, by the computing system, an input image and an input text string associated with the input image;
extracting, by the computing system, one or more answer spans from the input text string;
respectively processing, by the computing system, each answer span and the input text string with a machine-learned question generation model to generate, as an output of the machine-learned question generation model, a respective question text string;
respectively processing, by the computing system, each respective question text string and the input image with a machine-learned visual question answering model to determine a respective answer score for the corresponding answer span; and
generating, by the computing system, an alignment score for the input image and the input text string based on the respective answer score for each answer span.

19. The one or more non-transitory computer-readable media of claim 18, wherein the one or more answer spans comprise a plurality of answer spans, and wherein generating, by the computing system, the alignment score for the input image and the input text string comprises averaging the respective answer scores associated with the plurality of answer spans.

20. The one or more non-transitory computer-readable media of claim 18, wherein respectively processing, by the computing system, each respective question text string and the input image with the machine-learned visual question answering model to determine the respective answer score for the corresponding answer span comprises:
structuring the respective question text string and the respective answer span as binary question; and
determining the respective answer score as a probability of the machine-learned visual question answering model providing a positive binary output.
